(19) United States
(12) Patent Application Publication
(10) Pub. No.: US 2016/0130048 A1
(43) Pub. Date: May 12, 2016

(54) PROTECTION SYSTEM FOR CONTAINER AND BOTTLE PROVIDED WITH SUCH A PROTECTION SYSTEM

(71) Applicant: AXILONE PLASTIQUE, Auray (FR)

(72) Inventor: Jean-Paul DENECE, Baden (FR)

(21) Appl. No.: 14/896,481

(22) PCT Filed: Jun. 5, 2014
(86) PCT No.: PCT/FR2014/051347

§ 371 Date: Dec. 7, 2015

(30) Foreign Application Priority Data
Jun. 7, 2013 (FR) 13 55293

(51) Int. Cl. B65D 47/26; B05B 1/32; B05B 9/01; B65D 53/02

(52) U.S. Cl. CPC B65D 47/266; B65D 53/02; B05B 1/326; B05B 9/01

(57) ABSTRACT

The invention relates to a protection system (1) for a device (2) for dispensing a product, in particular a cosmetic product, contained in a container (3), the system (1) including: elements for attaching a lid to the container (3); a cap (11) including at least two protection portions (12, 13), wherein at least one of the protection portions (12, 13), referred to as movable, is rotatably mounted, the cap (11) being capable of adopting two end positions: a closed position and an open position; elements (14) for actuating the cap (11) between the two end positions; the actuation elements (14) including a ring (15) that is rotatably mounted on the attachment elements and elements (16) for transmitting the rotation of the ring (15) to the movable portion (12, 13) of the cap (11).

### FIELD OF THE INVENTION

The invention relates to the field of protection systems for containers.

More specifically, the invention relates to a protection system that is particularly suitable for cosmetics, such as perfumes, creams, or lipsticks, for which the container may be a bottle, jar, or tube.

To block access to the product inside the container, for example to prevent exposing the product to the air and causing deterioration, prevent it from spilling, or prevent actuation of a dispensing device such as a spray nozzle, a protection system commonly referred to as a cap, or lid, is placed on the container.

### BACKGROUND OF THE INVENTION

This cap is generally in the form of a removable additional part, attached to the container. When the user wishes to access the product inside the container, the user must remove the cap by detaching it from the container. The user could then drop and lose the cap. In addition, when the cap is in place on the container, it is generally retained in place by snap-fitting. As the snap-fitting must be easily undone by the user in order to remove the cap, it is often weak enough that the cap can be removed inadvertently, for example by impacts or vibrations affecting the container. Therefore the cap can easily be lost, allowing the product to escape from the container.

Caps have therefore been proposed that do not require detachment from the container to provide access to the product.

Document FR 1,502,545 describes a cover for an aerosol. The cover substantially forms a hemisphere, its first quarter-sphere being fixed to the bottle by elements of a shaft and its second quarter-sphere, the cap, being movable. The cap is mounted so as to pivot relative to the first quarter-sphere by elements of hinges. Pivoting the cap uncovers a spray nozzle which is then accessible to the user. Pressing on the spray nozzle releases the product

Document EP 1,092,650 proposes, in a manner substantially similar to what is proposed in document FR 1,502,545, a protective cap having a substantially hemispherical shape, comprising a top cap fixed on the bottle, forming an opening. A protective element of complementary shape to the opening of the top cap can move within the top cap by rotating about an axis, to cover the opening.

In these two documents, the user must act on the movable member, in this case the cap or protective element in the form of a spherical dome; a tongue-like element projecting from the dome must therefore be provided to facilitate user handling. This conflicts with the rounded appearance of the whole. In addition, the movable member slides over the fixed part. The generated friction can be unpleasant for the user, as it can catch while sliding and can damage the movable element.

Document U.S. Pat. No. 5,027,982 proposes forming the cap for an aerosol by elements of two cylindrical parts which extend the shape of the container: an outer part and an inner part. The outer part comprises two overlapping openings in an upper surface and in the cylindrical surface. The inner part comprises an opening for the spray nozzle and an actuator button. The outer part pivots on the inner part so that when an opening in the outer part uncovers the actuator button, the second opening uncovers the spray nozzle.

Document U.S. Pat. No. 3,729,119 also proposes forming a cap for an aerosol which extends the cylindrical shape of the container by elements of an inner cap and an overcap, with springs interposed between them. The overcap has two openings and the inner cap comprises an opening to accommodate the spray nozzle. The overcap is pivotable on the inner cap, to allow aligning one of its openings with the spray nozzle. At the same time, the springs spread apart the inner cap and overcap, allowing the user to introduce a finger into an opening of the overcap and press an actuator button on the inner cap to activate the spray nozzle.

In these two documents, the generally cylindrical and smooth shape of the assembly formed by the container and the cap is desirable because aerosols are involved.

However, especially in the field of perfume bottles, the user is more drawn to caps giving an identifiable character to the bottle, in order to more easily distinguish the bottle from others.

There is therefore a need for a new protection system for a product contained in a container, for example such as a perfume bottle, which remedies the disadvantages of the prior art.

### SUMMARY OF THE INVENTION

For this purpose, a first object of the invention is to provide a protection system for a product contained in a container, providing access to the product without the system having to be completely detached from the container.

A second object of the invention is to provide a protection system for a product contained in a container, which allows providing an attractive aesthetic appearance for a user.

A third object of the invention to provide a protection system for a product contained in a container, which is simple and pleasurable to use.

A fourth object of the invention is to provide a protection system for a product contained in a container, which is adaptable to any form of container.

A fifth object of the invention is to provide a protection system for a product contained in a container, which is inexpensive.

A description of the invention as characterized in the claims is provided below.

According to a first aspect, the invention relates to a protection system for a product, particularly a cosmetic product, contained in a container. The protection system comprises:
attachment means for attachment to the container, the attachment elements comprising a central opening to provide access to the product inside the container;
a cap comprising at least two protection portions, at least one of the protection portions said to be movable as it is mounted so as to rotate about a transverse axis of rotation carried by the attachment means, the cap being able to adopt two extreme positions:
   a closed position where the protection portions meet, the cap covering the central opening;
   an open position where the protection portions are apart from one another, the cap uncovering the central opening;
actuation elements for moving the cap between the two extreme positions.

The actuation elements comprise a ring mounted on the attachment elements so as to rotate about a longitudinal axis and transmission elements mounted between the ring and the cap. Rotation of the ring about the longitudinal axis causes rotation about the transverse axis of rotation of the at least one movable protection portion between the two positions of the cap.

The protection system further comprises locking elements between the ring and the attachment means, for locking the closed position of the cap; the locking elements are engaged to prevent rotation of the ring about the longitudinal axis relative to the attachment elements when the cap is in the closed position and are disengaged to allow rotation of the ring about the longitudinal axis relative to the attachment elements when the cap is in the open position.

With a simple rotational movement, without completely detaching the cap from the container, it is then possible to access the product inside the container. The rotational movement can be performed with one hand, facilitating manipulation of the system. In addition, it places no limitations on possible forms of the cap. The locking elements can prevent unwanted opening of the cap, but do not continually apply force on the cap, because once the elements are disengaged they no longer apply any force and cannot interfere with the rotational movement about the longitudinal axis of the ring relative to the attachment means, facilitating manipulation.

According to a first embodiment, the transmission elements comprise a cam type of linkage. For this purpose, the ring carrying on an inner surface portion a cam profile extending at least partially in a direction parallel to the longitudinal axis and along an arc about the longitudinal axis. The at least one movable protection portion carries a tab cooperating with the cam profile such that rotation of the ring about the longitudinal axis causes movement of the tab of the movable portion in the direction parallel to the longitudinal axis and rotation of the at least one movable protection portion about its axis of rotation.

The rotational movement of the ring is then transmitted by sliding to the movable protection portions, giving a pleasant feeling of effortlessness to the user manipulating the ring.

In a second embodiment, the transmission elements comprise a rack-and-pinion type of linkage. A pinion is carried by the at least one movable protection portion about the transverse axis. The rack is carried on an inner surface portion of the ring of the actuation means.

Advantageously, the assembly of protection portions is movable relative to the attachment means, such that the angle between the protection portions, when the cap is in the open position, can be greater than if a single protection portion is movable.

In a first example, the protection portions are portions of the same sphere. Preferably, according to this first example, the protection portions are then two in number, each portion being a quarter of the sphere and being movable about the same axis of rotation. The visual appearance of a spherical dome provided by the cap in the closed position is particularly attractive to the user. In addition, the protection portions move apart to allow the cap to transition to the open position in a manner reminiscent of the petals of a flower, in an original manner that is pleasing to the user.

According to a second example, the protection portions are portions of a same cylinder.

The system may further comprise locking elements between the ring and the at least one movable protection portion, for locking the closed position of the cap. A predefined torque must be applied to the ring to unlock the closed position, in order to prevent unwanted opening of the cap.

According to one exemplary embodiment, the locking elements for locking the cap in the closed position comprise a finger projecting from the at least one movable protection portion, the finger having a free end surface, and comprise a projecting flange on the ring. The flange has a friction surface facing the free end surface of the finger, so that when the cap is in the closed position, the friction surface of the flange is in planar contact with the end surface of the finger; the friction thus generated prevents the ring from pivoting in the direction that places the cap in the open position unless appropriate torque is applied.

According to a second aspect, the invention relates to a bottle for packaging a product, particularly a cosmetic product such as perfume, comprising a container and comprising a protection system as set forth above. The bottle can then be equipped with a dispensing device, for example a spray valve as is often the case for perfume bottles.

### BRIEF DESCRIPTION OF THE DRAWINGS

The figures in the drawings will now be briefly described.

FIG. 1 is a side view of a container, for example a perfume bottle, equipped with a protection system for a product contained in a container comprising a cap in a closed position.

FIG. 2 is a perspective view of the container of FIG. 1.

FIG. 3 is a view similar to that of FIG. 2, with the cap in the open position.

FIG. 4 is a perspective view of the protection system of FIG. 1, according to a first embodiment, with the element referred to as a ring having been removed.

FIG. 5 is a perspective view of the ring of the embodiment of FIG. 4.

FIG. 6 is a cross-sectional view of the cap and ring of the embodiment of FIG. 4, with the cap in an open position.

FIG. 7 is a three-quarter section view of the cap and ring of the embodiment of FIG. 4, with the cap in a closed position and with the transmission elements visible.

FIG. 8 is a section view similar to that of FIG. 7, along a different section plane, with the locking elements visible.

FIG. 9 is a perspective view of the protection system of FIG. 1, according to a second embodiment, with the element referred to as a ring having been removed.

FIG. 10 is a perspective view of the ring of the embodiment of FIG. 9.

FIG. 11 is a cross-sectional view of the cap and ring of the embodiment of FIG. 9, with the cap in an open position.

FIG. 12 is a cross-sectional view of the cap and ring of the embodiment of FIG. 9, with the cap in a closed position.

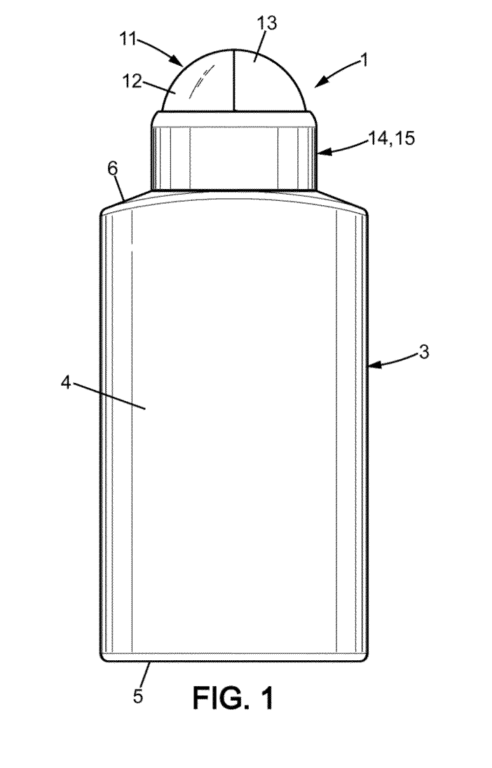

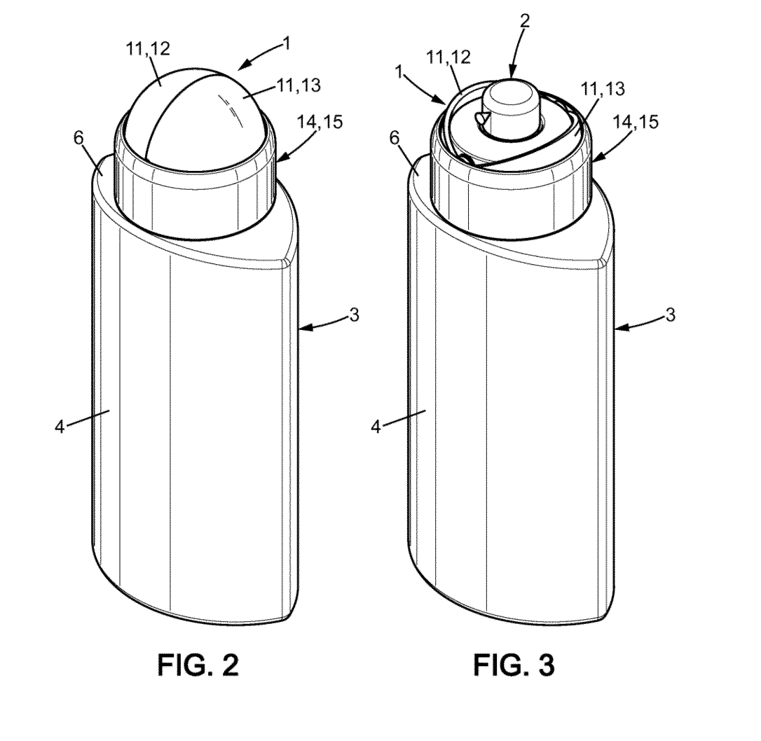

### DETAILED DESCRIPTION OF THE INVENTION

Below is a detailed account of several embodiments of the invention, accompanied by examples and with reference to the drawings.

The invention relates to a protection system 1 for a product contained in a container, particularly for a cosmetic product. The product is contained in a container 3 with which a dispensing device 2 can be connected or integrated.

The container can be in any form. For example, the container 3 has a body 4, closed off at one end by a base 5 and extending toward a second end terminating in a neck, so as to form a shoulder 6. The second end is open, to provide access to the product inside the container 3.

The dispensing device 2 is placed on the open end of the container 3, to facilitate or control access to the product inside the container 3. Thus, the dispensing device 2 is also understood to mean a simple opening which allows the product to escape under the effect of gravity, or allows the user to directly access the product with his or her fingers for example, or any other means providing access to the product inside the container 3. According to one particular embodiment, the dispensing device 2 is a spray nozzle.

The container 3 shown in the figures is in particular a container for a bottle intended for packaging a perfume type of cosmetic product. However, it may be a container for a stick of lipstick, for a jar of cream, or for a stick or tube of roll-on deodorant.

The protection system 1 comprises attachment elements 7 for fastening to the container 3. The attachment elements 7 comprise a central opening 8, so that they can fit on the dispensing device 2 while allowing access to the product inside the container 3.

For example, the attachment elements 7 are in the form of a substantially annular part which comprises an outer surface portion 9 which is substantially cylindrical about a longitudinal axis XX, and a base 10 adapted to be fixed to the shoulder 6 and/or neck of the container 3.

The protection system 1 further comprises a cap 11 having at least two protection portions 12, 13.

At least one of the protection portions 12, 13 is said to be movable because it is mounted so as to rotate about a transverse axis YY of rotation substantially perpendicular to the longitudinal axis XX, and carried by the attachment elements 7. Thus, by rotating the movable protection portion 12, 13, the cap 11 can assume two extreme positions:
an open position where the protection portions 12, 13 meet, with the cap 11 covering the central opening 8, to hide for example the dispensing device 2;
a closed position where the protection portions 12, 13 are apart from one another, with the cap 11 exposing the central opening 8, to uncover for example the dispensing device 2.

Thus, in the open position, the protection system 1 allows access to the product inside the container 3, while in the closed position, the protection system 1 blocks access to the product. The dispensing device 2 is also protected when the cap 11 is in the closed position, which is particularly advantageous for preventing it from unexpected activated. Indeed, particularly when the dispensing device is a pump or spray nozzle, prolonged action on the dispensing device 2 can completely empty the container 3. Such an action can occur for example when the container 3 is being carried, for example in a bag, due to the effect of impacts and/or vibrations.

The protection system 1 then comprises actuation elements 14 for moving the cap 11 between the two extreme positions. The actuation elements 14 comprise a ring 15 mounted on the attachment elements 7 so as to rotate about the longitudinal axis XX. Transmission elements 16 are mounted between the ring 15 and the cap 11, for transmitting rotation from the ring 15 to the movable protection portion 12, 13. Rotation of the ring 15 about the longitudinal axis XX is thus converted into rotation about the transverse axis YY of rotation.

The ring 15 is preferably annular, or at least rotationally symmetrical around the longitudinal axis XX. The ring 15 has an inner surface portion 17 that is substantially cylindrical with its axis coincident with the longitudinal axis XX, so as to facilitate rotation of the ring 15 on the outer surface portion 9 of the also cylindrical portion of the attachment elements 7.

Advantageously, the dimensions of each movable portion 12, 13 allow providing a closed surface rising from the ring 15 when the cap 11 is in the closed position, completely protecting the dispensing device 2 from the outside environment.

Preferably, each protection portion 12, 13 is defined by a curved cross-section, meaning that there is at least one sectional plane of the protection system 1 in which each of the protection portions 12, 13 has a non-zero radius of curvature. The two protection portions 12, 13 are also preferably complementary to each other, so that when the cap 11 is in the closed position, they form a substantially smooth surface to the eye of a user, or at least a regular surface.

The number of protection portions 12, 13 may vary, and the shapes and dimensions of each protection portion 12, 13 can be adapted accordingly.

The number of movable protection portions 12, 13 may also vary. Preferably, all the protection portions 12, 13 are rotatable about the same transverse axis YY of rotation.

Thus, according to a first example, which is the one in the figures, the protection portions 12, 13 are two in number and form a hemisphere when the cap 11 is closed. For example, each protection portion 12, 13 is a quarter of the same sphere, such that when the cap is closed, the two portions, respectively 12, 13, meet by coming into contact along one of their edges referred to as proximal, respectively 18, 19. Alternatively, each protection portion 12, 13 is a quarter of a sphere of different dimensions. More specifically, a first protection portion 12 is a quarter of a sphere having an outside diameter substantially equal to or slightly smaller than the inside diameter of the sphere of which the second protection portion 13 represents a quarter. Thus, when the cap 11 is in the closed position, the two protection portions 12, 13 partially overlap where they meet. Preferably, the difference in dimensions is small enough to give the user the overall impression of a hemisphere when the cap is in the closed position.

Preferably, the dimensions of the movable protection portion or portions 12, 13 allow transitioning from the closed position to the open position by at least partially entering the ring 15. More specifically, the distance measured in a plane perpendicular to the transverse axis YY between any point on the outer surface of the movable portion 12, 13 and the axis YY of rotation is less than or substantially equal to the distance in the same plane between the inner surface portion 17 of the ring 15 and the axis YY of rotation.

Thus, according to the first example, the radius of the hemisphere formed by the protection portions 12, 13 is less than the inner radius of the ring 15. During the transition from the open position to the closed position, there is therefore little or no contact between the movable protection portions 12, 13 and the ring, reducing the friction. The rotation of the ring therefore occurs smoothly, without unpleasant catching. In addition, the ring may have a curved surface portion 17′ complementary to the spherical shape of the movable protection portions 12, 13, in order to guide them in their rotation about the transverse axis YY.

The dimensions of the movable portion or portions 12, 13 are also adapted to the dispensing device 2. Thus, the dimensions of each protection portion 12, 13 are preferably sufficiently large to prevent interference with the dispensing device 2 when the cap 11 is closed. In addition, in the open position, the protection portions 12, 13 are spaced sufficiently apart from each other to allow access to the dispensing device 2.

According to a second example, the protection portions 12, 13 are cylindrical portions having a straight edge. Here again, the protection portions 12, 13 may be portions of the same cylinder or of cylinders of different dimensions.

Two specific embodiments of the protection system 1 will now be described, where there are two protection portions 12, 13, each forming a quarter of the same sphere.

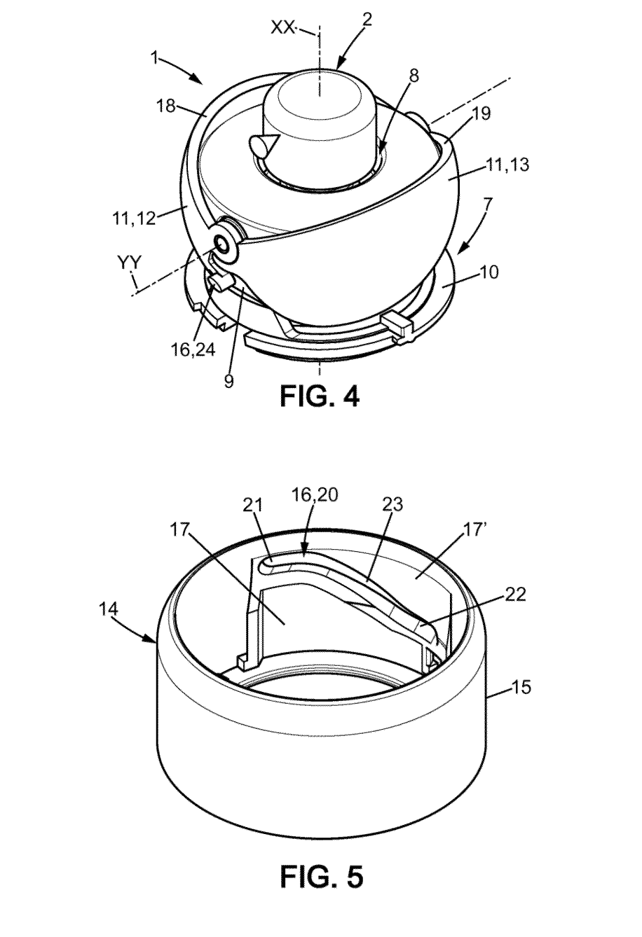

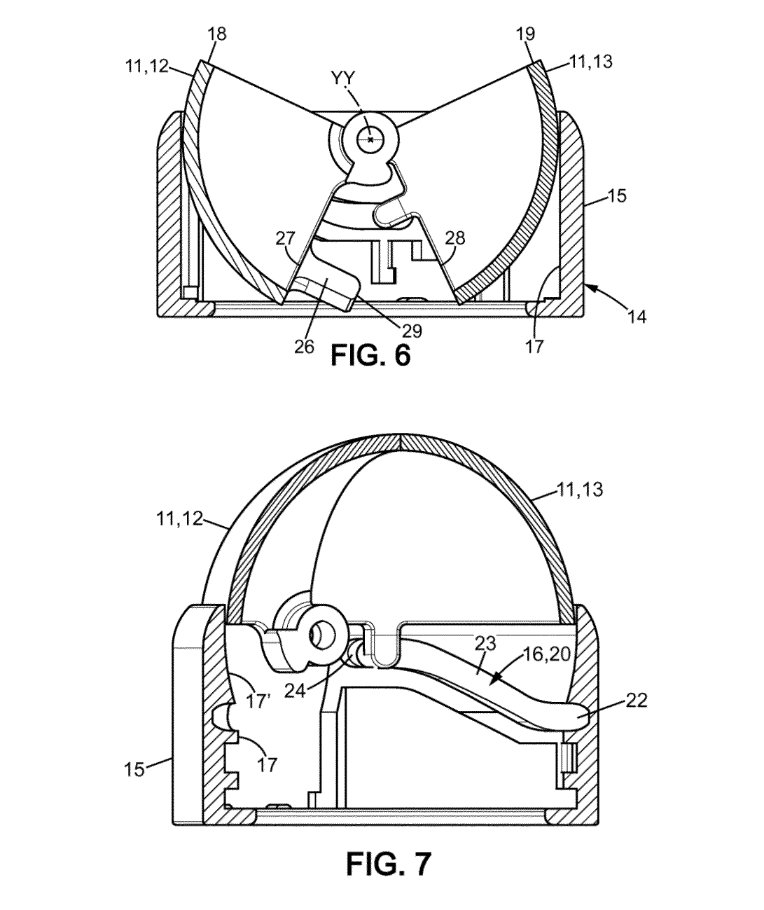

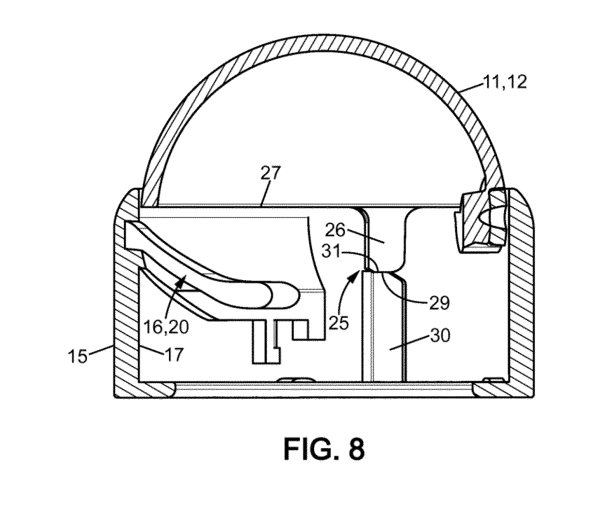

In a first embodiment, illustrated in FIGS. 4 to 8, the transmission elements 16 comprise a cam-like linkage. For this purpose, the inner surface portion 17 of the ring 15 carries a cam profile 20, which extends at least partially in a direction parallel to the longitudinal axis XX and in an arc around the longitudinal axis XX. More specifically, the cam profile 20 has two end sections 21, 22, offset relative to one another along the longitudinal axis XX, with an intermediate section 23 connecting the two end sections 21, 22. The movable protection portion 12 supports a tab 24 which cooperates with the cam profile 20.

Thus, rotation of the ring 15 about the longitudinal axis XX relative to the attachment elements 7 causes a sliding movement of the tab 24 along the cam profile 20, in a direction parallel to the longitudinal axis XX, from one end section 21 of the cam profile 20 to the other end section 22, so that the movable protection portion 12 is rotated about the transverse axis YY of rotation. Each end section 21, 22 corresponds to an extreme position of the cap 11. For example, when the tab 24 is in the first end section 21, furthest from the body 4 of the container 3, the cap 11 is in the closed position; when the lug 24 is in the second end section 22, closest to the body 4 of the container 3, the cap 11 is in the open position.

When the two protection portions 12, 13 are both rotatable about the transverse axis YY of rotation, the ring 15 then comprises, on the inner surface portion 17, two cam profiles 20 that are symmetrical to each other with respect to the longitudinal axis XX. Each movable protection portion 12, 13 then supports a tab 24, each tab 24 respectively cooperating with one of the cam profiles 20. Thus, rotation of the ring about the longitudinal axis XX causes a simultaneous rotation of the two movable protection portions 12, 13.

The dimension of each cam profile 20, between the two end sections 21, 22, is chosen so that, according to the embodiment described herein, each protection portion 12, 13 can pivot through the largest possible angle.

Thus, the spacing between the protection portions 12, 13 can be chosen to be as wide as possible, each protection portion 12, 13 being at least partially retracted into the ring 15 when the cap 11 is in the open position. Such an arrangement is particularly advantageous when the dispensing device 2 must be as uncovered as possible in order to provide access to the product inside the container 3. For example, when the dispensing device is a spray nozzle, when the cap 11 is open, the protection portions 12, 13 allow user access to the actuation button and uncover the valve opening. Advantageously, the valve opening is oriented along the transverse axis YY, so that the spray is also oriented along the transverse axis YY.

Advantageously, the actuation elements 14 further comprise locking elements 25 for locking the cap 11 in the closed position, arranged between the attachment elements 7 and the ring 15. As the cap 11, specifically portions 12, 13, is rotatably fixed about the longitudinal axis XX relative to the attachment elements 7, the locking elements 25 between the attachment elements 7 and the ring 15 can be indirect and be placed between the ring 15 and the cap 11.

According to one exemplary embodiment, the locking elements 25 rely on friction, and therefore each respective movable protection portion 12, 13 is provided with a finger 26 projecting from an edge referred to as distal, respectively 27, 28. The finger 26 has a free end surface 29. The ring 15 is then provided with a flange 30 projecting from its inner surface portion 17, presenting a friction surface 31 facing the free end surface 29 of the finger 26. The flange 30 is positioned such that when the tab 24 is in the first end section 21 of the cam profile 20, meaning when the cap 11 is in the closed position, the friction surface 31 of the flange 30 is in planar contact with the end surface 29 of the finger 26. The locking elements 25 are then said to be engaged. The friction thus generated prevents the ring 15 from pivoting about the longitudinal axis XX relative to the attachment elements 7 in the direction that places the cap 11 in the open position, unless appropriate torque is exerted. The appropriate torque is predefined to be sufficiently large to prevent the ring 15 from pivoting under the effect of impacts and/or vibrations. At the same time, the appropriate torque must be low enough for the average intended user of the product in the container 3 to apply manually in order to disengage the locking elements 25, in other words so that the contact between the friction surface 31 and the end surface 29 of the finger 26 is ended by pivoting the ring 15 on the attachment elements 7 about the longitudinal axis XX.

Thus, the locking elements 25 come into play only when the cap 11 is closed. Once the locking elements 25 are disengaged, there is no longer any friction between the friction surface 31 and the end surface 29 of the finger 26 when the ring 15 is pivoted on the attachment elements 7 about the longitudinal axis XX. When the contact between the friction surface 31 and the end surface 29 of the finger 26 has just been broken, portions 12, 13 of the cap 11 are not yet truly separated from one another. However, as the ring 15 has been released from its friction with the cap 11, it can pivot on the attachment elements 7 until the spacing between portions 12, 13 of the cap is at a maximum by exerting less torque than is required to disengage the locking elements 25.

Thus, from the closed position, the ring 15 is pivoted about the longitudinal axis XX in a first direction, which causes rotation of the one or more movable protection portions 12, 13 about the transverse axis YY of rotation by means of the transmission elements 16, possibly by applying sufficient torque to overcome friction between the finger 26 and the flange 30 of the locking elements 25, the latter then being disengaged. Due to their spherical shape, the transverse protection portion or portions 12, 13 can slide on the curved inner surface portion 17′ of the ring 15 and at least partially enter the ring 15. The resulting spacing between the two protection portions 12, 13 uncovers the dispensing device 2, placing the cap 11 in the open position, in a manner reminiscent to the user of flower petals unfurling to reveal the pistil.

To transition to the closed position from the open position, the ring 15 is pivoted about the longitudinal axis XX relative to the attachment elements 7, in a second direction opposite to the first, causing the protection portions 12, 13 to exit the ring 15 and draw close to one another, covering the dispensing device 2. The locking elements 25 are then engaged by the friction between the friction surface 31 and the end surface 29 of the finger 26. The locking elements 25 therefore, when engaged, exert force between the attachment elements 7 and the ring 15, preventing rotation of the ring 15 about the longitudinal axis XX relative to the attachment elements 7, and when disengaged, leave the ring 15 free to rotate relative to the attachment elements 7.

It is thus simple to rotate the ring 15 to transition the cap from the closed position to the open position, with nothing preventing its movement once the contact between the friction surface 31 and the end surface 29 of the finger 26 is ended. Furthermore, the locking elements 25, when they are disengaged, are inoperative when the cap 11 is in the open position, meaning in the absence of action by the user, the cap 11 remaining in the open position which facilitates access to the dispensing device 2 and to the product. Finally, the locking elements 25 indicate to the user that he or she has reached the closed position of the cap 11 by making the user feel the extra effort then required to rotate the ring 15. The locking elements 25 are particularly suitable and advantageous for manual operation of the protection system 1.

The cap 11 in the closed position forms a spherical dome that is original and is attractive to the user.

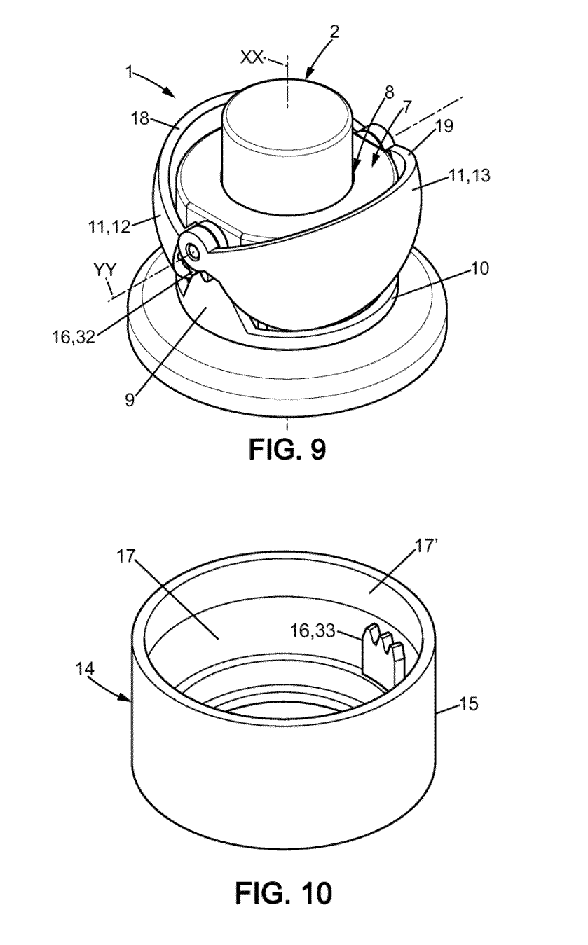

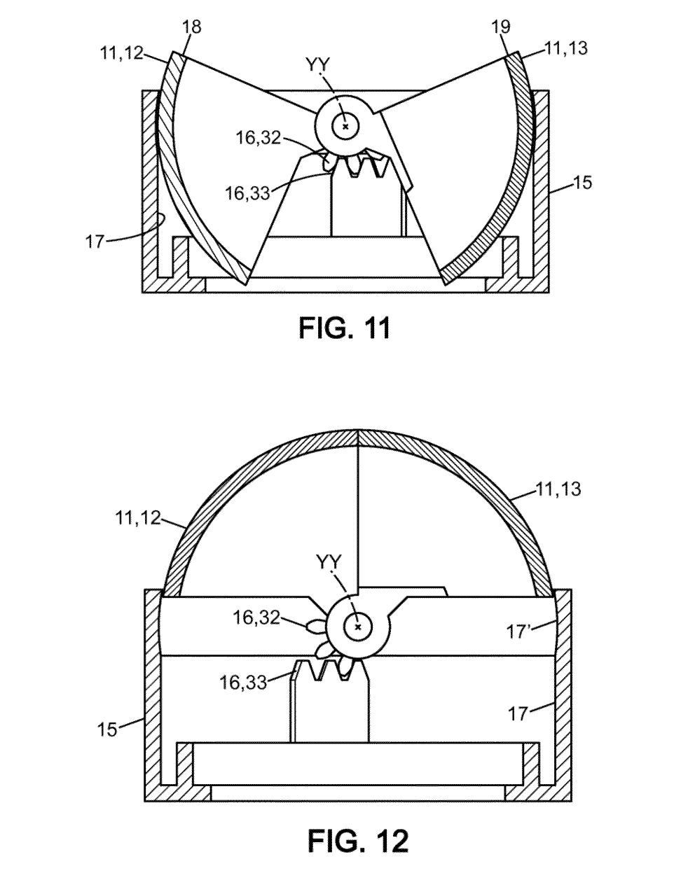

According to a second embodiment, illustrated in particular in FIGS. 9 to 12, the transmission elements 16 comprise a rack-and-pinion type of linkage. A pinion 32 is carried by the movable protection portion 12, rotating about the transverse axis YY of rotation. A rack 33, complementary to the pinion 32 and extending along at least a portion of a circle around the longitudinal axis XX, is carried by the inner surface portion 17 of the ring 15. The teeth 33 of the rack are oriented parallel to the longitudinal axis XX. Thus, rotation of the ring 15 and therefore of the rack 33 drives the pinion 32, and thus the protection portion 12, to rotate about the transverse axis of rotation YY.

Similarly to the above, when the two protection portions 12, 13 are both rotatable about the transverse axis YY of rotation, each protection portion 12, 13 is equipped with a pinion 32 rotating about the transverse axis YY of rotation. For example, pinions 32 may be placed on each side of the cap 11 relative to the transverse axis YY of rotation. The ring 15 is then equipped on its inner surface portion 17 with at least two racks 33, symmetrical to each other relative to the longitudinal axis XX, each engaging with one of the pinions 32. Thus, rotation of the ring 15 about the longitudinal axis XX causes simultaneous rotation of the protection portions 12, 13 about the transverse axis YY.

Locking elements for locking in the closed position, such as those previously described, may also be provided (not shown in FIGS. 9 to 12).

The transition from the open position to the closed position and vice versa occurs as above, by simple rotation of the ring 15.

The various components of the protection system 1 may be made of any material. Preferably, they are made of plastic. However, some or all may be made of metal or ceramic for example.

The protection system thus obtained allows creating original shapes that are pleasing to the eye. The cap 11 thus formed by the protection portions 12, 13 is not removable, but is able to assume an open position allowing access to the dispensing device 2. Manipulation is easy, and with one hand. Manufacturing costs are not increased significantly.

In addition, the design of the described protection system is simple, as the protection system is independent of the dispensing device 2. Thus, the protection system can be easily adapted to any type of container 3 and any type of dispensing device 2 without the design of the container or device being impacted. In other words, the protection system can be adapted to a container 3 equipped with any dispensing device 2, or the described protection system can even replace a protection system previously mounted on a container 3.

1-10. (canceled)

11. Protection system for a product, particularly a cosmetic product, contained in a container (3), wherein the protection system comprises:
attachment elements for attachment to the container, the attachment elements comprising a central opening to provide access to the product inside the container;
a cap comprising at least two cap protection portions, at least one of the protection portions being movable as it is mounted so as to rotate about a transverse axis of rotation carried by the attachment elements, the cap being able to adopt two extreme positions:
a closed position where the protection portions meet, the cap covering the opening;
an open position where the protection portions are apart from one another, the cap uncovering the central opening;
actuation elements for moving the cap between the two extreme positions;
wherein the actuation elements comprise a ring mounted on the attachment elements so as to rotate about a longitudinal axis and transmission elements mounted between the ring and the cap so that rotation of the ring about the longitudinal axis causes rotation about the transverse axis of rotation of the at least one movable protection portion between the two positions of the cap, and wherein the system comprises locking elements between the ring and the attachment elements, the locking elements being engaged to prevent rotation of the ring about the longitudinal axis relative to the attachment elements when the cap is in the closed position and being disengaged to allow rotation of the ring about the longitudinal axis relative to the attachment elements when the cap is in the open position.

12. The protection system according to claim 11, wherein the transmission elements comprise a cam type of linkage, the ring carrying on an inner surface portion a cam profile extending at least partially in a direction parallel to the longitudinal axis and along an arc about the longitudinal axis, and the at least one movable protection portion carrying a tab cooperating with the cam profile such that rotation of the ring about the longitudinal axis causes movement of the tab of the movable portion in the direction parallel to the longitudinal axis and rotation of the at least one movable protection portion about its axis of rotation.

13. The protection system according to claim 11, wherein the transmission elements comprise a rack-and-pinion type of linkage, the pinion being carried by the at least one movable protection portion about the transverse axis, the rack being carried on an inner surface portion of the ring of the actuation elements.

14. The protection system according to claim 11, wherein the assembly of protection portions is movable relative to the attachment elements.

15. The protection system according to claim 11, wherein the protection portions are portions of a same sphere.

16. The protection system according to claim 15, wherein the protection portions are two in number, each portion being a quarter of the same sphere and being movable about the same axis of rotation.

17. The protection system according to claim 11, wherein the protection portions are portions of the same cylinder.

18. The protection system according to claim 11, wherein the locking elements for locking the cap in the closed position comprise a finger projecting from the at least one movable protection portion, the finger having a free end surface, and comprise a projecting flange on the ring, the flange having a friction surface facing the free end surface of the finger, so that when the cap is in the closed position, the friction surface of the flange is in planar contact with the end surface of the finger, the friction thus generated preventing the ring from pivoting in the direction that places the cap in the open position unless appropriate torque is applied.

19. Bottle for packaging a product, particularly a cosmetic product such as perfume, wherein the bottle comprises a container, and a protection system according to claim 11.

20. Bottle according to claim 19, wherein the bottle comprises a dispensing device such as a spray valve.
